(19) United States
(12) Patent Application Publication
(10) Pub. No.: US 2021/0105831 A1
(43) Pub. Date: Apr. 8, 2021

(54) RANDOM ACCESS METHOD AND APPARATUS AND COMMUNICATION DEVICE

(71) Applicant: GUANGDONG OPPO MOBILE TELECOMMUNICATIONS CORP., LTD., Dongguan (CN)

(72) Inventors: CONG SHI, Dongguan (CN); Ning Yang, Dongguan (CN)

(21) Appl. No.: 17/121,365

(22) Filed: Dec. 14, 2020

Related U.S. Application Data
(63) Continuation of application No. PCT/CN2019/081813, filed on Apr. 8, 2019.

(30) Foreign Application Priority Data
Jun. 14, 2018 (CN) 201810615826.7

(51) Int. Cl. H04W 74/08

(52) U.S. Cl. CPC H04W 74/0833

(57) ABSTRACT

Provided in embodiments of the disclosure are a method and apparatus for random access and a communication device. The method includes: determining, by a terminal, a first channel access type corresponding to a random access procedure according to at least one of: an event that triggers the random access procedure, or a service type that triggers the random access procedure; and using the first channel access type, by the terminal, for data transmission in the random access procedure.

### CROSS REFERENCE TO RELATED APPLICATION

The present application is a continuation of International Application No. PCT/CN2019/081813 filed on Apr. 8, 2019, which claims priority to Chinese Patent Application No. 201810615826.7, filed on Jun. 14, 2018, the entire contents of which are incorporated herein by reference in their entirety.

### TECHNICAL FIELD

Embodiments of the disclosure relate to the technical field of mobile communications, and particularly to a method and device for random access and a communication device.

### BACKGROUND

With development of wireless communication technologies, a licensed-assisted access-Long Term Evolution (LAA-LTE) system provides a service for a terminal device based on a carrier aggregation (CA) architecture by taking a carrier in a licensed spectrum as a primary carrier and taking a carrier in an unlicensed spectrum as a secondary carrier. In the LAA-LTE system, the primary carrier may be used for ensuring initial access of the terminal device and transmission performance of some critical services, and the secondary carrier in the unlicensed spectrum may be configured to transmit a non-critical bigdata service of the terminal device, thereby achieving the purpose of load balance for an LTE cell. In the LAA-LTE system, a random access channel (RACH) procedure is implemented on the primary carrier, and thus a RACH function is not optimized for the unlicensed spectrum.

With development of mobile networks, an unlicensed spectrum has been applied to a New Radio (NR) system, and NR in unlicensed spectrum (NR-U) needs to support an LAA operation mode as well as a stand-alone (SA) operation mode. For the SA operation mode, an RACH procedure needs to be completed in an unlicensed spectrum. How to optimize an RACH function for an unlicensed spectrum is a problem to be solved.

### SUMMARY

In embodiments of the disclosure, provided is a method for random access, including: determining, by a terminal, a first channel access type corresponding to a random access procedure according to at least one of: an event that triggers the random access procedure, or a service type that triggers the random access procedure; and using the first channel access type, by the terminal, for data transmission in the random access procedure.

In embodiments of the disclosure, provided is a device for random access, including: a determination unit, configured to determine a first channel access type corresponding to a random access procedure according to at least one of: an event that triggers the random access procedure, or a service type that triggers the random access procedure; and a transmission unit, configured to use the first channel access type for data transmission in the random access procedure.

In embodiments of the disclosure, provided is a communication device, including a processor and a memory, wherein the memory is configured to store a computer program, and the processor is configured to call and run the computer program stored in the memory to execute the above method for random access.

In embodiments of the disclosure, provided is a chip for implementing the above method for random access.

Specifically, the chip may include a processor, configured to call and run a computer program from a memory to enable a device installed with the chip to execute the above method for random access.

In embodiments of the disclosure, provided is a computer-readable storage medium, configured to store a computer program which enables a computer to execute the above method for random access.

In embodiments of the disclosure, provided is a computer program product, including computer program instructions enabling a computer to execute the above method for random access.

In embodiments of the disclosure, provided is a computer program which, when running on a computer, enables the computer to execute the above method for random access.

### BRIEF DESCRIPTION OF THE DRAWINGS

FIG. 1 illustrates a schematic diagram of an architecture of a communication system according to an embodiment of the disclosure.

FIG. 2(a) illustrates a schematic diagram of a contention-based RACH procedure according to an embodiment of the disclosure.

FIG. 2(b) illustrates a schematic diagram of a contention-free RACH procedure according to an embodiment of the disclosure.

FIG. 3 illustrates a schematic flowchart of a method for random access according to an embodiment of the disclosure.

FIG. 4 illustrates a schematic structural diagram of composition of a device for random access according to an embodiment of the disclosure.

FIG. 5 illustrates a schematic structural diagram of a communication device according to an embodiment of the disclosure.

FIG. 6 illustrates a schematic structural diagram of a chip according to an embodiment of the disclosure.

FIG. 7 illustrates a schematic block diagram of a communication system according to an embodiment of the disclosure.

### DETAILED DESCRIPTION

For convenience of understanding the technical solutions of the embodiments of the disclosure, related terms involved in the embodiments of the disclosure will be described below.

1) Unlicensed Spectrum

An unlicensed spectrum is a spectrum available for communication of radio devices and is divided by a country and region. The spectrum is usually considered as a shared spectrum, namely communication devices in different communication systems may utilize the spectrum without applying to the government for dedicated spectrum grants, as long as the regulatory requirements made by the country or region for the spectrum are met. To enable various communication systems, which perform wireless communication by utilizing an unlicensed spectrum, to coexist on the unlicensed spectrum friendly, some countries or regions have made regulatory requirements that need to be satisfied during use of the unlicensed spectrum. For example, in European regions, a communication device follows a listen before talk (LBT) rule. That is to say, the communication device needs to firstly perform channel listening, before sending a signal on a channel in an unlicensed spectrum, and the communication device can send a signal only if a channel listening result indicates that the channel is idle. If the channel listening result of the communication device for the channel in the unlicensed spectrum indicates that the channel is busy, the communication device may not send a signal.

Moreover, to ensure fairness, during each time of transmission, a duration in which the communication device performs data transmission using the channel in the unlicensed spectrum may not exceed a maximum channel occupation time (MCOT).

For another example, to avoid sub-band interference to a signal transmitted on a channel in an unlicensed spectrum as well as to improve detection accuracy of a communication device in detecting the channel in the unlicensed spectrum, the signal transmitted on the channel in the unlicensed spectrum needs to occupy at least a certain proportion of a bandwidth of the channel. For example, for a 5 GHz band, the signal occupies 80% of the bandwidth of the channel, and for a 60 GHz band, the signal occupies 70% of the bandwidth of the channel.

For another example, to avoid transmission of an important signal such as a radar signal on a channel in an unlicensed spectrum being affected due to that another signal is transmitted with an excessively high power on the channel, a maximum power spectral density for a communication device to perform signal transmission using the channel in the unlicensed spectrum is specified in regulations.

2) Network Architecture

The embodiments of the disclosure may be applied to various communication systems, for example, a global system for mobile communications (GSM), a code division multiple access (CDMA) system, a wideband code division multiple access (WCDMA) system, a general packet radio service (GPRS), a universal mobile telecommunication system (UMTS), a long term evolution (LTE) system as well as an evolved version of LTE system such as an advanced LTE (LTE-A) system, an NR system as well as an evolved version of NR system such as an NR-U system, or a next-generation communication system.

Generally, connections supported by a conventional communication system are usually limited in number and are also easy to implement. However, with development of communication technologies, a mobile communication system will not only support conventional communication but also support, for example, device-to-device (D2D) communication, machine-to-machine (M2M) communication, machine-type communication (MTC) and vehicle-to-vehicle (V2V) communication.

The communication system in the embodiments of the disclosure may be applied to a CA scenario, or may be applied to an SA networking scenario.

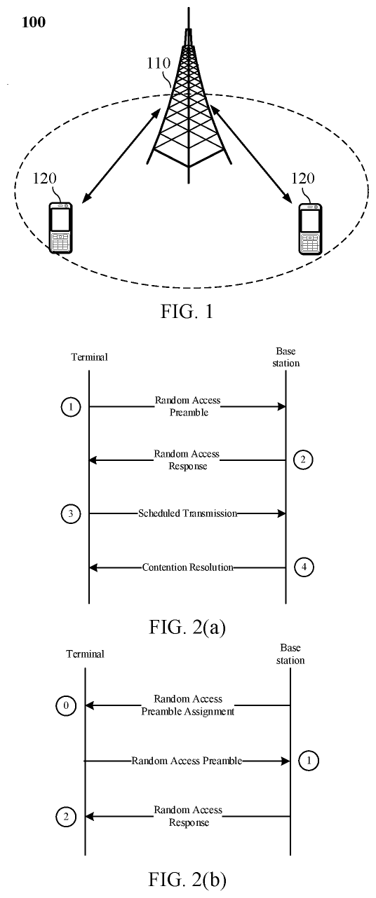

Exemplarily, a communication system 100 to which the embodiments of the disclosure are applied is as illustrated in FIG. 1. The communication system 100 may include a network device 110, and the network device 110 may be a device communicating with a terminal device 120 (or referred to as a communication terminal and a terminal). The network device 110 may provide communication coverage for a specific geographical area and may communicate with a terminal device within the coverage. Alternatively, the network device 110 may be a base transceiver station (BTS) in a GSM or CDMA system, may also be a NodeB (NB) in a WCDMA system, or may be an evolved Node B (eNB or eNodeB) in an LTE system or a wireless controller in a cloud radio access network (CRAN). Alternatively, the network device may be a mobile switching center, a relay station, an access point, a vehicle-mounted device, a wearable device, a hub, a switch, a network bridge, a router, a network-side device in a 5^{th}-Generation (5G) network, a network device in a future evolved public land mobile network (PLMN) or the like.

The communication system 100 further includes at least one terminal device 120 within the coverage of the network device 110. The term “terminal” as used here includes, but is not limited to, being connected via a wired line, for example, via a public switched telephone network (PSTN), a digital subscriber line (DSL), a digital cable, or a direct cable connection; and/or via another data connection/network; and/or via a wireless interface, e.g., for a cellular network, a wireless local area network (WLAN), a digital telephone network such as a DVB-H network, a satellite network, or an AM-FM broadcast transmitter; and/or via a device of another terminal configured to receive/send a communication signal; and/or via an Internet of things (IoT) device.

A terminal configured to communicate via a wireless interface may be referred to as a “wireless communication terminal”, a “wireless terminal” or a “mobile terminal”. Examples of a mobile terminal include but are not limited to: a satellite phone or a cell phone; a personal communication system (PCS) terminal which can combine a cellular radio phone with data processing, faxing and data communication capabilities; a personal digital assistant (PDA) that may include a radio phone, a pager, Internet/intranet access, a Web browser, a notebook, a calendar and/or a global positioning system (GPS) receiver; a conventional laptop and/or handheld receiver; or other electronic devices including a radio telephone transceiver.

The terminal may refer to an access terminal, a user equipment (UE), a subscriber unit, a user station, a mobile station, a remote station, a remote terminal, a mobile device, a user terminal, a wireless communication device, a user agent or a user device. The access terminal may be a cell phone, a cordless phone, a session initiation protocol (SIP) phone, a wireless local loop (WLL) station, a personal digital assistant (PDA), a hand-held device with a wireless communication function, a computing device or other processing devices connected to a wireless modem, a vehicle-mounted device, a wearable device, a terminal device in a 5G network, a terminal in a future evolved PLMN or the like.

Alternatively, device-to-device (D2D) communication may be implemented between terminal devices 120.

Alternatively, the 5G system or the 5G network may also be referred to as a New Radio (NR) system or an NR network.

A method and device for random access and a communication device are provided in embodiments of the disclosure. A random access procedure of a terminal on an NR-U spectrum is improved, and the access efficiency of a system is improved.

FIG. 1 illustrates a network device and two terminal devices exemplarily. Alternatively, the communication system 100 may include multiple network devices, and there may be another number of terminal devices within coverage of each network device. This is not limited in the embodiments of the disclosure.

Alternatively, the communication system 100 may further include another network entity such as a network controller and a mobility management entity. This is not limited in the embodiments of the disclosure.

It is to be understood that, in the embodiments of the disclosure, a device with a communication function in a network/system may be referred to as a communication device. With the communication system 100 illustrated in FIG. 1 as an example, communication devices may include a network device 110 and a terminal device 120 that have a communication function, and the network device 110 and the terminal device 120 may be the specific devices mentioned above. Description will not be made here.

The communication devices may further include other devices in the communication system 100, for example, other network entities such as a network controller and a mobility management entity. This is not limited in the embodiments of the disclosure.

It is to be understood that terms “system” and “network” in the disclosure are usually used interchangeably in the disclosure. In the disclosure, the term “and/or” is only an association relationship describing associated objects and represents that three relationships may exist. For example, A and/or B may represent three cases: i.e., independent existence of A, existence of both A and B, and independent existence of B. In addition, the character “/” in the disclosure usually represents that an “or” relationship between associated objects before and after the character.

3) RACH Procedure

3.1) An RACH procedure may be triggered by the following events: initial access from radio resource control (RRC)_IDLE; an RRC connection re-establishment procedure; handover; downlink (DL) or uplink (UL) data arrival during RRC_CONNECTED when a UL synchronization status is “non-synchronized”; transition from an RRC inactive state to another state, e.g., an RRC active state (transition from RRC_INACTIVE); request for other System Information (SI); Beam failure recovery; and the event that a logical channel is not configured with a corresponding scheduling request (SR) configuration, and the logical channel triggers a scheduling request.

3.2) Form of RACH procedure

(1) Contention-based RACH (CB-RACH) procedure, as illustrated in FIG. 2(a).

(2) Contention-free RACH (CF-RACH) procedure, as illustrated in FIG. 2(b).

NR in an unlicenced spectrum needs to support both an licence-assisted access (LAA) operation mode and a stand alone (SA) operation mode. For the SA operation mode, an RACH procedure needs to be completed in an unlicensed spectrum. Therefore, an RACH function needs to be further optimized according to a requirement of the unlicensed spectrum, and an access requirement, such as listen before talk (LBT), of the unlicensed spectrum also needs to be satisfied.

For NR in an unlicensed spectrum, the following scenarios are supported: carrier aggregation of an NR licensed spectrum (primary carrier) and an NR unlicensed spectrum (secondary carrier), a dual-connectivity architecture of an LTE licensed spectrum (primary carrier) and an NR unlicensed spectrum (secondary carrier), an SA architecture of an NR unlicensed spectrum, an NR cell containing a DL unlicensed spectrum and an UL licensed spectrum, and a dual-connectivity architecture of an NR licensed spectrum (primary carrier) and an NR unlicensed spectrum (secondary carrier).

For the NR unlicensed spectrum (NR-U) in the SA architecture, the UE needs to perform an RACH procedure on the unlicensed spectrum, and how the RACH operates on the unlicensed spectrum, for example how to determine an access channel, needs to be defined.

4) Channel Access Priority Class

Two access types are defined in LAA, which are Type1 and Type2.

For Type1, a terminal may select different channel access priority classes according to service types. Further, for Type1, there are four channel access priority classes as illustrated in Table 1.

TABLE 1

| Channel access | Quality of Service (QoS) |
|---|---|
| priority class (p) | Class Identifier (QCI) |
| 1 | 1, 3, 5, 65, 66, 69, 70 |
| 2 | 2, 7 |
| 3 | 4, 6, 8, 9 |
| 4 | — |

For Type2, before transmitting a physical uplink shared channel (PUSCH), the terminal needs to perform listening for a fixed duration of 25 us.

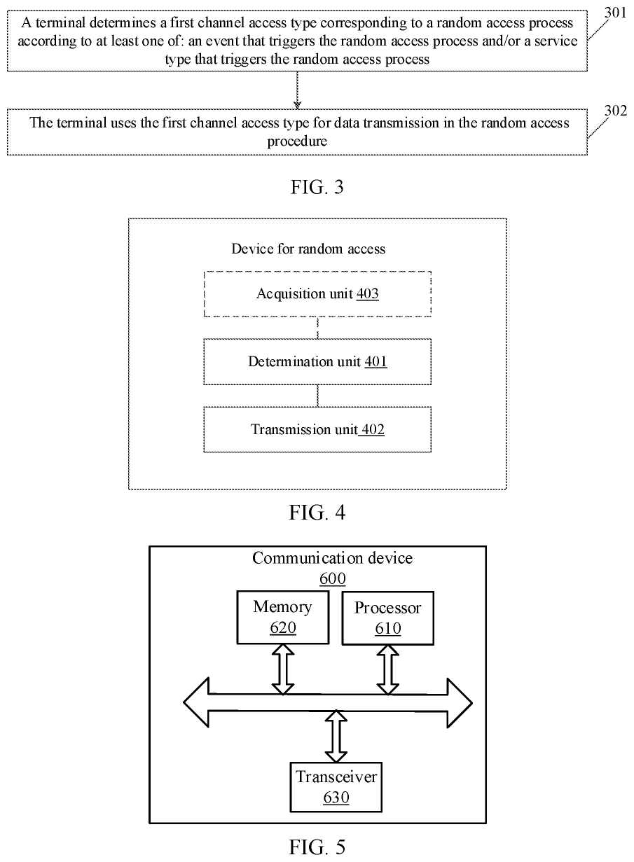

FIG. 3 illustrates a schematic flowchart of a method for random access according to an embodiment of the disclosure. As illustrated in FIG. 3, the method for random access includes the following actions.

In action 301, a terminal determines a first channel access type corresponding to a random access procedure according to at least one of: an event that triggers the random access procedure, or a service type that triggers the random access procedure.

In the embodiments of the disclosure, the terminal may be any device capable of communicating with a network side, such as a mobile phone, a laptop, a tablet, a desktop and a vehicle-mounted terminal.

In the embodiments of the disclosure, a network architecture to which the terminal belongs may be, but not limited to, NR-U in an SA architecture, and the UE needs to perform an RACH procedure, i.e., a random access procedure, in an unlicensed spectrum. As illustrated in FIG. 2(a) and FIG. 2(b), four messages are involved in the random access procedure, which are an Msg1, an Msg2, an Msg3 and an Msg4. In FIG. 2(a), a random access preamble is transmitted through an Msg1, a random access response is transmitted through an Msg2, scheduled transmission is implemented through an Msg3, and contention resolution is transmitted through an Msg4. In FIG. 2(b), a random access preamble is transmitted through an Msg1, and a random access response is transmitted through an Msg2.

In the embodiments of the disclosure, the event triggering the random access procedure includes at least one of: initial access from RRC_IDLE; an RRC connection re-establishment procedure; handover; DL or UL data arrival during RRC_CONNECTED when a UL synchronization status is “non-synchronized”; transition from an RRC inactive state to an RRC active state or to an RRC idle state (transition from RRC_INACTIVE); request for other SI; beam failure recovery; and the event that a logical channel is not configured with a corresponding scheduling request (SR) configuration, and the logical channel triggers a scheduling request.

In the embodiments of the disclosure, the service type triggering the random access procedure refers to a service type having data to transmit when the random access procedure is triggered by the following events: DL data or UL data arrival during RRC_CONNECTED when the UL synchronization status is “non-synchronized”; or, a logical channel having no corresponding scheduling request (SR) configuration.

In the embodiments of the disclosure, each channel access type has a corresponding relationship with at least one of: a respective event that triggers a random access procedure, or a respective service type that triggers the random access procedure. The terminal receives first configuration information from a network device, the first configuration information including the corresponding relationship of the channel access type with at least one of: the respective event that triggers the random access procedure, or the respective service type that triggers the random access procedure.

For example, the corresponding relationship, configured by the network, of events triggering a random access procedure with channel access types is illustrated in Table 2.

TABLE 2

| Event | Priority |
|---|---|
| Initial access from RRC_IDLE; | Low priority |
| RRC Connection Re-establishment procedure; | |
| DL or UL data arrival during RRC_CONNECTED | |
| when UL synchronization status is “non-synchronized”; | |
| Transition from RRC_INACTIVE; | |
| Request for Other SI; | |
| Handover; | High priority |
| Beam failure recovery. | |

If the terminal initiates a random access procedure triggered by the event of Beam failure recovery, the terminal uses a high-priority channel access type. If the terminal initiates a random access procedure triggered by the event of Request for Other SI, the terminal uses a low-priority channel access type.

In 302, the terminal uses the first channel access type for data transmission in the random access procedure.

In the embodiments of the disclosure, after determining, based on the first configuration information, the first channel access type corresponding to at least one of: the present event that triggers the random access procedure, or the present service type that triggers the random access procedure, the terminal uses the first channel access type for data transmission in the random access procedure Specifically, 1) the terminal uses the first channel access type for transmission of an Msg1 and an Msg3 in the random access procedure. Alternatively, 2) the terminal uses a specified channel access type for transmission of an Msg1 in the random access procedure and uses the first channel access type for transmission of an Msg3 in the random access procedure. Herein, the specified channel access type is, for example, a channel access type with a highest priority class.

In the embodiments of the disclosure, in response to that the terminal receives no first configuration information, or, the terminal receives the first configuration information but the first configuration information does not include the first channel access type corresponding to at least one of: the event that triggers the random access procedure, or the service type that triggers the random access procedure, the terminal uses a specified channel access type for transmission of an Msg1 and an Msg3 in the random access procedure. Herein, the specified channel access type is, for example, a channel access type with a highest priority class.

In the embodiments of the disclosure, a second channel access type to be used for the Msg2 in the random access procedure is determined based on DL data multiplexed with the Msg2; and/or, a third channel access type to be used for the Msg4 in the random access procedure is determined based on DL data multiplexed with the Msg4.

Further, 1) if the Msg2 is multiplexed with no DL data, the second channel access type to be used for Msg2 is a specified channel access type determined by the network device; and if the Msg2 is multiplexed with DL data, the second channel access type to be used for Msg2 is determined by the network device based on a priority of the DL data multiplexed with the Msg2. 2) If the Msg4 is multiplexed with no DL data, the third channel access type to be used for the Msg4 is the specified channel access type determined by the network device; and if the Msg4 is multiplexed with DL data, the third channel access type to be used for the Msg4 is determined by the network device based on a priority of the DL data multiplexed with the Msg4. Herein, the specified channel access type is, for example, a channel access type with a highest priority class.

In the embodiments of the disclosure, the first channel access type is a first type or a second type.

When the first channel access type is the first type, an access priority of the first channel access type is a fixed priority. Herein, the fixed priority is for example a defined high priority, and a listening duration corresponding to the high priority is a fixed duration of 25 us.

When the first channel access type is the second type, the access priority of the first channel access type is configurable. It is configured that each priority corresponds to a respective different channel listening duration and window.

FIG. 4 illustrates a structural diagram of composition of a device for random access according to an embodiment of the disclosure. As illustrated in FIG. 4, the device for random access includes a determination unit 401 and a transmission unit 402.

The determination unit 401 is configured to determine a first channel access type corresponding to a random access procedure according to at least one of: an event that triggers the random access procedure, or a service type that triggers the random access procedure.

The transmission unit 402 is configured to use the first channel access type for data transmission in the random access procedure.

In an implementation, the transmission unit 402 is configured to use the first channel access type for transmission of an Msg1 and an Msg3 in the random access procedure.

In an implementation, the transmission unit 402 is configured to use a specified channel access type for transmission of an Msg1 in the random access procedure, and use the first channel access type for transmission of an Msg3 in the random access procedure.

In an implementation, each channel access type has a corresponding relationship with at least one of: a respective event that triggers a random access procedure, or a respective service type that triggers the random access procedure. The device further includes an acquisition unit 403.

The acquisition unit 403 is configured to receive first configuration information from a network device. The first configuration information includes the corresponding relationship of the channel access type with at least one of: the respective event that triggers the respective random access procedure, or the respective service type that triggers the respective random access procedure.

In an implementation, in response to that the acquisition unit 403 receives no first configuration information, or, the acquisition unit 403 receives the first configuration information but the first configuration information does not include the first channel access type corresponding to at least one of: the event that triggers the random access procedure, or the service type that triggers the random access procedure, the transmission unit 402 uses a specified channel access type for transmission of an Msg1 and an Msg3 in the random access procedure.

In an implementation, a second channel access type to be used for an Msg2 in the random access procedure is determined based on downlink (DL) data multiplexed with the Msg2; and/or a third channel access type to be used for an Msg4 in the random access procedure is determined based on DL data multiplexed with the Msg4.

In an implementation, in response to that the Msg2 is multiplexed with no DL data, the second channel access type to be used for the Msg2 is a specified channel access type determined by a network device, or in response to that the Msg2 is multiplexed with DL data, the second channel access type to be used for the Msg2 is determined by the network device based on a priority of the DL data multiplexed with the Msg2; and/or in response to that the Msg4 is multiplexed with no DL data, the third channel access type to be used for the Msg4 is the specified channel access type determined by the network device, or in response to that the Msg4 is multiplexed with DL data, the third channel access type to be used for the Msg4 is determined by the network device based on a priority of the DL data multiplexed with the Msg4.

In an implementation, the first channel access type is a first type or a second type. When the first channel access type is the first type, an access priority of the first channel access type is a fixed priority. When the first channel access type is the second type, the access priority of the first channel access type is configurable. It is configured that each priority corresponds to a respective different channel listening duration and window.

In an implementation, the event that triggers the random access procedure includes at least one of: initial access from RRC_IDLE; an RRC connection re-establishment procedure; handover; DL data or UL data arrival during RRC_CONNECTED when a UL synchronization status is “non-synchronized”; transition from an RRC inactive state to an RRC active state or to an RRC idle state; request for other SI; beam failure recovery; and an event that a logical channel is configured with no corresponding scheduling request (SR) configuration and the logical channel triggers a scheduling request.

In an implementation, the service type that triggers the random access procedure is a service type having data to transmit when the random access procedure is triggered by at least one of the following events: DL data or UL data arrival during RRC_CONNECTED when the UL synchronization status is “non-synchronized”; or a logical channel having no corresponding scheduling request (SR) configuration.

It is understood by those skilled in the art that the related description about the above device for random access of the embodiments of the disclosure may be understood with reference to the related description about the method for random access of the embodiments of the disclosure.

FIG. 5 illustrates a schematic structural diagram of a communication device 600 according to an embodiment of the disclosure. The communication device may be a terminal device. The communication device 600 illustrated in FIG. 5 includes a processor 610, and the processor 610 may call and run a computer program from a memory to implement the method in the embodiments of the disclosure.

Alternatively, as illustrated in FIG. 5, the communication device 600 may further include a memory 620. The processor 610 may call and run the computer program from the memory 620 to implement the method in the embodiments of the disclosure.

The memory 620 may be a separate device independent of the processor 610 and may also be integrated into the processor 610.

Alternatively, as illustrated in FIG. 5, the communication device 600 may further include a transceiver 630, and the processor 610 may control the transceiver 630 to communicate with another device. In particular, information or data may be sent to the another device, or information or data may be received from the another device.

The transceiver 630 may include a transmitter and a receiver. The transceiver 630 may further include antennae, and the number of the antennae may be one or more.

Alternatively, the communication device 600 may specifically be a network device of the embodiments of the disclosure, and the communication device 600 may implement corresponding flows implemented by the network device in each method of the embodiments of the disclosure. Description will not be made here for simplicity.

Alternatively, the communication device 600 may specifically be the mobile terminal/terminal device of the embodiments of the disclosure, and the communication device 600 may implement corresponding flows implemented by the mobile terminal/terminal device in each method of the embodiments of the disclosure. Description will not be made here for simplicity.

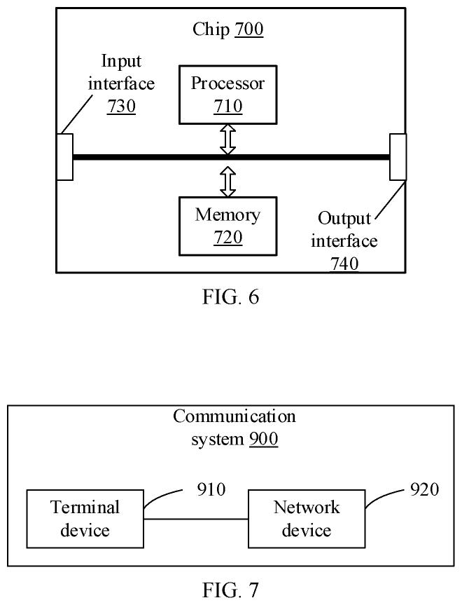

FIG. 6 illustrates a schematic structural diagram of a chip according to another embodiment of the disclosure. The chip 700 illustrated in FIG. 6 includes a processor 710, and the processor 710 may call and run a computer program from a memory to implement the method in the embodiments of the disclosure.

Alternatively, as illustrated in FIG. 6, the chip 700 may further include a memory 720. The processor 710 may call and run the computer program from the memory 720 to implement the method in the embodiments of the disclosure.

The memory 720 may be a separate device independent of the processor 710 and may also be integrated into the processor 710.

Alternatively, the chip 700 may further include an input interface 730. The processor 710 may control the input interface 730 to communicate with another device or chip. Specifically information or data may be acquired from the another device or chip.

Alternatively, the chip 700 may further include an output interface 740. The processor 710 may control the output interface 740 to communicate with the another device or chip. Particularly, information or data may be output to the another device or chip.

Alternatively, the chip may be applied to the network device of the embodiments of the disclosure, and the chip may implement corresponding flows implemented by the network device in each method of the embodiments of the disclosure. Description will not be made here for simplicity.

Alternatively, the chip may be applied to the mobile terminal/terminal device of the embodiment of the disclosure, and the chip may implement corresponding flows implemented by the mobile terminal/terminal device in each method of the embodiment of the disclosure. Description will not be made here for simplicity.

It is to be understood that the chip mentioned in the embodiment of the disclosure may also be referred to as a system-level chip, a system chip, a chip system or a system on chip, etc.

FIG. 7 illustrates a schematic block diagram of a communication system 900 according to an embodiment of the disclosure. As illustrated in FIG. 5, the communication system 900 includes a terminal device 910 and a network device 920.

The terminal device 910 may be configured to realize corresponding functions realized by the terminal device in the method, and the network device 920 may be configured to realize corresponding functions realized by the network device in the method. Description will not be made here for simplicity.

Through the above technical solutions, different channel access priority classes are used in random access procedures triggered by different types of events and/or services, so that the access efficiency of a system may be improved, and a random access procedure of the terminal in an NR-U spectrum is improved.

It is to be understood that the processor in the embodiments of the disclosure may be an integrated circuit chip and has a signal processing capability. During implementation, each action of the method embodiments may be completed by an integrated logical circuit of hardware in the processor or an instruction in a software form. The processor may be a universal processor, a digital signal processor (DSP), an application-specific integrated circuit (ASIC), a field programmable gate array (FPGA) or another programmable logical device, a discrete gate or transistor logical device, and a discrete hardware component, and can implement or execute each method, action and logical block diagram disclosed in the embodiments of the disclosure. The universal processor may be a microprocessor or the processor may also be any conventional processor and the like. The actions of the method disclosed in combination with the embodiments of the disclosure may be directly embodied to be executed and completed by a hardware decoding processor or executed and completed by a combination of hardware and software modules in the decoding processor. The software module may be located in a mature storage medium in this field such as a random-access memory (RAM), a flash memory, a read-only Memory (ROM), a programmable ROM (PROM), electrically erasable PROM (EEPROM), and a register. The storage medium is located in a memory, and the processor reads information in the memory, and completes the actions of the method in combination with hardware.

It can be understood that the memory in the embodiments of the disclosure may be a volatile memory or a nonvolatile memory, or may include both the volatile and nonvolatile memories. The nonvolatile memory may be a ROM, a PROM, an erasable PROM (EPROM), an EEPROM or a flash memory. The volatile memory may be a RAM, and is used as an external cache. By way of example but not limiting description, RAMs in various forms may be used, such as a static RAM (SRAM), a dynamic RAM (DRAM), a synchronous DRAM (SDRAM), a double data rate SDRAM (DDRSDRAM), an enhanced SDRAM (ESDRAM), a synchlink DRAM (SLDRAM) and a direct rambus RAM (DR RAM). It is to be noted that the memory of a system and method described in the disclosure is intended to include, but not limited to, memories of these and any other proper types.

It is to be understood that the above description of memories are exemplary but not limiting. For example, the memory in the embodiments of the disclosure may also be an SRAM, a DRAM, an SDRAM, a DDR SDRAM, an ESDRAM, an SLDRAM and a DR RAM. That is, the memory in the embodiments of the disclosure is intended to include, but not limited to, memories of these and any other proper types.

In embodiments of the disclosure, also provided is a computer-readable storage medium, which is configured to store a computer program.

Alternatively, the computer-readable storage medium may be applied to a network device in the embodiments of the disclosure, and the computer program enables a computer to execute corresponding flows implemented by the network device in each method of the embodiments of the disclosure. Description will not be made here, for simplicity.

Alternatively, the computer-readable storage medium may be applied to a mobile terminal/terminal device in the embodiments of the disclosure, and the computer program enables a computer to execute corresponding flows implemented by the mobile terminal/terminal device in each method of the embodiments of the disclosure. Description will not be made here, for simplicity.

In embodiments of the disclosure, also provided is a computer program product including a computer program instructions.

Alternatively, the computer program product may be applied to a network device in the embodiments of the disclosure, and the computer program instruction enables a computer to execute corresponding flows implemented by the network device in each method of the embodiments of the disclosure. Description will not be made here, for simplicity.

Alternatively, the computer program product may be applied to a mobile terminal/terminal device in the embodiments of the disclosure, and the computer program instruction enables the computer to execute corresponding flows implemented by the mobile terminal/terminal device in each method of the embodiments of the disclosure. Description will not be made here, for simplicity.

In embodiments of the disclosure, also provided is a computer program.

Alternatively, the computer program may be applied to a network device in the embodiments of the disclosure, and the computer program runs in a computer to enable the computer to execute corresponding flows implemented by the network device in each method of the embodiments of the disclosure. Description will not be made here, for simplicity.

Alternatively, the computer program may be applied to a mobile terminal/terminal device in the embodiments of the disclosure, and the computer program runs in the computer to enable the computer to execute corresponding flows implemented by the mobile terminal/terminal device in each method of the embodiments of the disclosure. Description will not be made here, for simplicity.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software depends on particular applications and design constraints of the technical solutions. Professionals may realize the described functions for each particular application by use of different methods, but such realization shall not be construed falling out of the scope of the disclosure.

Those skilled in the art may clearly learn about that particular operation processes of the system, device and unit described above may refer to the corresponding processes in the method embodiment and will not be elaborated herein for convenient and brief description.

In the embodiments provided in the disclosure, it is to be understood that the disclosed system, device and method may be implemented in other forms. For example, the device embodiment described above is only schematic, and for example, division of the units is only logical function division, and other division manners may be used during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or in other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, various functional units in each embodiment of the disclosure may be integrated into a processing unit, each unit may also physically exist independently, and two or more than two units may also be integrated into one unit.

When being realized in form of software functional units and sold or used as independent products, the functions may also be stored in a computer-readable storage medium. Based on such an understanding, the technical solutions of the disclosure substantially, or parts making contributions to the conventional art, or part of the technical solutions may be embodied in form of software product, and the computer software product is stored in a storage medium, including a plurality of instructions configured to enable a computer device (which may be a personal computer, a server, a network device or the like) to execute all or part of the actions of the method in each embodiment of the disclosure. The abovementioned storage medium includes: various media capable of storing program codes such as a USB flash disk, a mobile hard disk, a ROM, a RAM, a magnetic disk or an optical disk.

The above is only detailed description of the disclosure and is not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for random access, comprising:
determining, by a terminal, a first channel access type corresponding to a random access procedure according to at least one of: an event that triggers the random access procedure, or a service type that triggers the random access procedure; and
using, by the terminal, the first channel access type for data transmission in the random access procedure.

2. The method of claim 1, wherein using, by the terminal, the first channel access type for data transmission in the random access procedure comprises:
using, by the terminal, the first channel access type for transmission of an Msg1 and an Msg3 in the random access procedure.

3. The method of claim 1, wherein using, by the terminal, the first channel access type for message transmission in the random access procedure comprises:
using, by the terminal, a specified channel access type for transmission of an Msg1 in the random access procedure, and
using, by the terminal, the first channel access type for transmission of an Msg3 in the random access procedure.

4. The method of claim 1, wherein each channel access type has a corresponding relationship with at least one of: a respective event that triggers a random access procedure, or a respective service type that triggers the random access procedure, and the method further comprises:
receiving, by the terminal, first configuration information from a network device, the first configuration information comprising the corresponding relationship of the channel access type with at least one of: the respective event that triggers the random access procedure, or the respective service type that triggers the random access procedure.

5. The method of claim 4, wherein
in response to that the terminal receives no first configuration information, or, the terminal receives the first configuration information but the first configuration information does not comprise the first channel access type corresponding to at least one of: the event that triggers the random access procedure, or the service type that triggers the random access procedure, the terminal uses a specified channel access type for transmission of an Msg1 and an Msg3 in the random access procedure.

6. The method of claim 1, wherein
a second channel access type to be used for an Msg2 in the random access procedure is determined based on downlink (DL) data multiplexed with the Msg2; and
a third channel access type to be used for an Msg4 in the random access procedure is determined based on DL data multiplexed with the Msg4.

7. The method of claim 6, wherein
in response to that the Msg2 is multiplexed with no DL data, the second channel access type to be used for the Msg2 is a specified channel access type determined by a network device, or in response to that the Msg2 is multiplexed with DL data, the second channel access type to be used for the Msg2 is determined by the network device based on a priority of the DL data multiplexed with the Msg2; and
in response to that the Msg4 is multiplexed with no DL data, the third channel access type to be used for the Msg4 is the specified channel access type determined by the network device, or in response to that the Msg4 is multiplexed with DL data, the third channel access type to be used for the Msg4 is determined by the network device based on a priority of the DL data multiplexed with the Msg4.

8. The method of claim 1, wherein the first channel access type is a first type or a second type;
when the first channel access type is the first type, an access priority of the first channel access type is a fixed priority; and
when the first channel access type is the second type, the access priority of the first channel access type is configurable, wherein it is configured that each priority corresponds to a respective different channel listening duration and window.

9. The method of claim 1, wherein the event that triggers the random access procedure comprises at least one of:
initial access from radio resource control (RRC)_IDLE;
an RRC connection re-establishment procedure;
handover;
DL data or uplink (UL) data arrival during RRC_CONNECTED when a UL synchronization status is “non-synchronized”;
transition from an RRC inactive state to an RRC active state or to an RRC idle state;
request for other system information (SI);
beam failure recovery; and
an event that a logical channel is configured with no corresponding scheduling request (SR) configuration and the logical channel triggers an SR.

10. The method of claim 1, wherein the service type that triggers the random access procedure is a service type having data to transmit when the random access procedure is triggered by at least one of the following events:
DL data or UL data arrival during RRC_CONNECTED when the UL synchronization status is “non- synchronized”; or
a logical channel having no corresponding scheduling request (SR) configuration.

11. A terminal, comprising: a processor, a memory and a transceiver, wherein
the processor is configured to determine a first channel access type corresponding to a random access procedure according to at least one of: an event that triggers the random access procedure, or a service type that triggers the random access procedure; and
the transceiver is configured to use the first channel access type for data transmission in the random access procedure.

12. The terminal of claim 11, wherein the transceiver is configured to use the first channel access type for transmission of an Msg1 and an Msg3 in the random access procedure.

13. The terminal of claim 11, wherein the transceiver is configured to:
use a specified channel access type for transmission of an Msg1 in the random access procedure, and
use the first channel access type for transmission of an Msg3 in the random access procedure.

14. The terminal of claim 11, wherein each channel access type has a corresponding relationship with at least one of: a respective event that triggers a random access procedure, or a respective service type that triggers the random access procedure, and the transceiver is further configured to:
receive first configuration information from a network device, the first configuration information comprising the corresponding relationship of the channel access type with at least one of: the respective event that triggers the respective random access procedure, or the respective service type that triggers the respective random access procedure.

15. The terminal of claim 14, wherein
in response to that the transceiver receives no first configuration information, or, the transceiver receives the first configuration information but the first configuration information does not comprise the first channel access type corresponding to at least one of: the event that triggers the random access procedure, or the service type that triggers the random access procedure, the transceiver uses a specified channel access type for transmission of an Msg1 and an Msg3 in the random access procedure.

16. The terminal of claim 11, wherein
a second channel access type to be used for an Msg2 in the random access procedure is determined based on downlink (DL) data multiplexed with the Msg2; and
a third channel access type to be used for an Msg4 in the random access procedure is determined based on DL data multiplexed with the Msg4.

17. The terminal of claim 16, wherein
in response to that the Msg2 is multiplexed with no DL data, the second channel access type to be used for the Msg2 is a specified channel access type determined by the network device, or in response to that the Msg2 is multiplexed with DL data, the second channel access type to be used for the Msg2 is determined by the network device based on a priority of the DL data multiplexed with the Msg2; and
in response to that the Msg4 is multiplexed with no DL data, the third channel access type to be used for the Msg4 is the specified channel access type determined by the network device, or in response to that the Msg4 is multiplexed with DL data, the third channel access type to be used for the Msg4 is determined by the network device based on a priority of the DL data multiplexed with the Msg4.

18. The terminal of claim 11, wherein the first channel access type is a first type or a second type;
when the first channel access type is the first type, an access priority of the first channel access type is a fixed priority; and
when the first channel access type is the second type, the access priority of the first channel access type is configurable, wherein it is configured that each priority corresponds to a respective different channel listening duration and window.

19. The terminal of claim 11, wherein the event that triggers the random access procedure comprises at least one of:
initial access from radio resource control (RRC)_IDLE;
an RRC connection re-establishment procedure;
handover;
DL data or uplink (UL) data arrival during RRC_CONNECTED when a UL synchronization status is “non-synchronized”;
transition from an RRC inactive state to an RRC active state or to an RRC idle state;
request for other System Information (SI);
beam failure recovery; and
an event that a logical channel is configured with no corresponding scheduling request (SR) configuration and the logical channel triggers an SR.

20. The terminal of claim 11, wherein the service type that triggers the random access procedure is a service type having data to transmit when the random access procedure is triggered by at least one of the following events:
DL data or UL data arrival during RRC_CONNECTED when the UL synchronization status is “non-synchronized”; or
a logical channel having no corresponding scheduling request (SR) configuration.
